(19) United States
(12) Patent Application Publication
(10) Pub. No.: US 2007/0247298 A1
(43) Pub. Date: Oct. 25, 2007

(54) Multiplicity of front and rear brake lights

(76) Inventor: Eero A. Laukkanen, Lantana, FL (US)

Correspondence Address: EERO A. LAUKKANEN, 720 NORTH DIXIE HWY APT 505, LANTANA, FL, 33462, US

(21) Appl. No.: 11/409,421

(22) Filed: Apr. 24, 2006

(51) Int. Cl. B60Q 1/44

(52) U.S. Cl. 340/479

(57) ABSTRACT

A vehicle has additional brake lights at the front as well as additional brake lights at the rear. The additional rear brake lights are mounted at the top or as high as possible and to the left and right sides. When a driver applies brakes these additional brake lights come on to alerting the following driver more than would the conventional rear brake lights. In addition another set of brake lights are placed at the front of the vehicle with their illumination directed forwardly. This alerts drivers in front of the vehicle as well as pedestrians that braking action occurs when these light go on.

### BACKGROUND OF THE INVENTION

The full potential of brake lights has not been utilized to its fullest extent. As a vehicle's brake lights are usually seen only from behind the vehicle it is easy to presume that the rear of a vehicle is the only place to have brake lights installed. However drivers in front of a vehicle are unaware of the application of brakes. It is clear that it is easier to take action if one can see danger than when one is unaware of danger. When brake lights are on it is an indication that some kind of action should be taken or needs to be taken. Seeing brake lights makes a driver instinctively react, perhaps slowing down or stopping, or at least makes one aware of the need to be cautious. The use of Center High-Mounted Stop Lamps (CHMSL), for example, at the rear of vehicles provides more visibility as more brake lights are provided.

Today's vehicles are built better than ever with improvements in brakes, tires, engines, more safety features, etc. But today's vehicles can also deceive one into being careless because the ease with which today's vehicle's can be driven, braked, speeded up or turned makes some feel invulnerable, particularly young drivers. Many vehicle collisions occur at intersections because stop signs are ignored, or drivers increase speed when lights change, or drivers react by slowing down when they are not expected to slow down. Pedestrians crossing at intersections are often unaware if a vehicle is or is not slowing down. Clearly any number of reasons exist where drivers and pedestrians could be helped if they were simply aware that a vehicle is braking.

Commercial vehicles, or trucks, are often neglected when it comes to brake lights. This may seem surprising since they are very well illuminated at the rear as well as along the top and sides. But these common lights do not represent any kind of warning signal, except to alert others of their presence on the road, and they too suffer from a lack of additional brake lights.

U.S. Pat. No. 6,690,272 to Hall provides brake lights at the front and conventional brake lights at the rear of a vehicle with a delay between the time the rear lights are illuminated and the front lights are illuminated. The Hall lights in the front of the vehicle are on the same level or lower as the headlights and there are no additional brake lights at the rear of the vehicle. Merely having various brake lights at the front and rear of vehicles is not sufficient; they must be seen clearly and quickly without delay.

### SUMMARY OF THE INVENTION

This invention relates to the art of brake lights, more particularly to a complete brake light system incorporating two sets of additional brake lights, one set at the back of a vehicle and one set at the front of a vehicle thus adding additional sources of illumination in a multi-light brake system. The provision of more light at the front and rear portions of any vehicle has the capacity to provide a greater perception of braking. The lights could be on the vehicle itself or attached thereto in some manner or could be on a trailer. These additional rear light sets are in addition to the usual and normal lights at the rear of vehicles including the standard Center High-Mounted Stop Lamps. With both of these additional brake lights the better it is to alert others that the vehicle is in the process of braking, whether they are the front or rear of the vehicle.

The brake light system can be made a part of original equipment or it can be an accessory brake light system for after market purposes.

### BRIEF DESCRIPTION OF THE SEVERAL VIEWS OF THE DRAWINGS

FIG. 1 is a top view of a vehicle incorporating additional front and rear brake lights according to the invention,

FIG. 2 is a rear view of a truck incorporating the first set of rear lights according to the present invention,

FIG. 3 is a perspective view of a flatbed or platform truck,

FIG. 4 is a rear view of a concrete transport truck,

FIG. 5 shows a convertible, with the top down, with additional rear brake lights,

FIG. 6 is a front view of a truck having high front bumpers with front facing brake lights,

FIG. 7 shows a first pattern of LED brake lights suitable at the front of a vehicle,

FIG. 8 shows a second pattern of LED brake lights suitable at the rear of a vehicle,

FIG. 9 shows an enclosure for the front brake lights,

FIG. 10 shows the side of an enclosure having a gradual slope,

FIG. 11 shows the side of an enclosure with a greater slope than that of FIG. 10,

FIG. 12 shows the side of an enclosure where the casing has a flat top, and

FIG. 13 is a view looking into a rear view mirror at a following vehicle.

### DETAILED DESCRIPTION OF THE INVENTION

The drawings, which are not drawn to scale, do not show all of the conventional lights such as back up lights and turn signals to avoid obscuring the drawings as they form no part of the present invention.

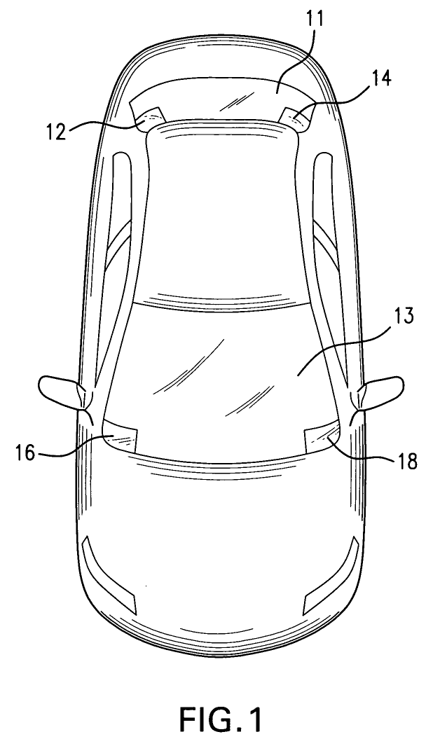

FIG. 1 illustrates a top view of a car or vehicle which is a generic representation of any vehicle, such as a sedan, van or SUV. It is assumed there are present conventional brake lights including Center High-Mounted Stop Lamps (CHMSL which are not shown. A first set of additional rear brake lights 12, 14, when viewed from above the vehicle, are placed at the top left and right of the vehicle's rear window 11 constituting a first set of lights according to the invention. These lights are Light Emitting Diodes (LEDs), the preferable light source, but they can be of any type such as bulbs or halogen lights, or any source of illumination typical in the art of brake lights. Each of the rear brake lights may be arranged in a generally rectangular shape. When brakes are applied not only are the usual rear brake lights illuminated but also the additional LEDs 12, 14. This additional illumination will alert a following driver more than only the typical brake lights because more lights will provide greater illumination. Many vehicles, particularly trucks and the like, have various colored lights at the rear but the additional brake lights must be red to denote braking. The additional sets of rear lights are fixed, or fixedly secured, to the top rear of the vehicle by any means known the art.

The teachings of the invention with respect to additional rear brake lights are applicable to any vehicle including automobiles and sedans of any type, vans, trucks, trailers, semi's, semi trucks, SUVs, or buses. Many trucks typically have square or rectangular rear configurations and may employ lights extending along the top portion. Normally these lights afford good illumination at night. While these lights clearly illuminate the vehicle they are not related to brake lights and clearly cannot give any indication of braking.

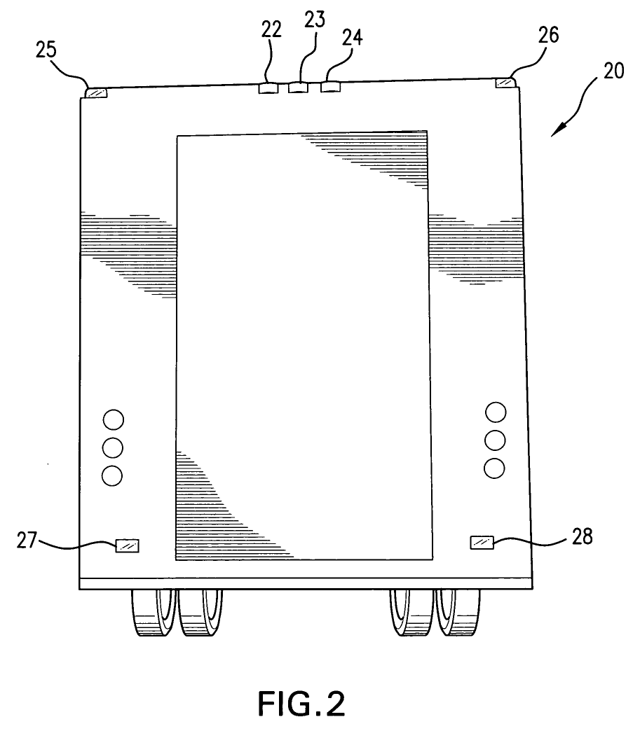

FIG. 2 is a rear view of a truck 20 with conventional illumination lights 22, 23 and 24 along the top rear, sometimes three as shown but often there many lights extending along the top. The lights 22, 23 and 24 are often in colors other than red and provide no indication of braking nor are they intended to do so. Numerals 25 and 26, to the left and right, respectively, of lights 22 and 24, are a first set of additional brake lights according to the invention and not merely lights of illumination. In the prior art when brakes are applied by a driver then lights 22, 23, 24, such as the yellow lights commonly seen on trucks, or other colors, are not caused to be illuminated and the driver following the vehicle is not aware of any braking action except that provided by the conventional brake lights 27 and 28 which are normally situated at the bottom left and right of the truck and which are often difficult to see.

However when brake lights 25 and 26 according to the invention are provided on the truck this will afford greater illumination as the brakes are applied and released. Moreover these lights are high, relative to the usual truck brake lights, to better alert the following driver that brakes have been applied. The lights 25, 26, while shown in a generally rectangular configuration, could be of any suitable shape and the invention is not limited to this specific shape.

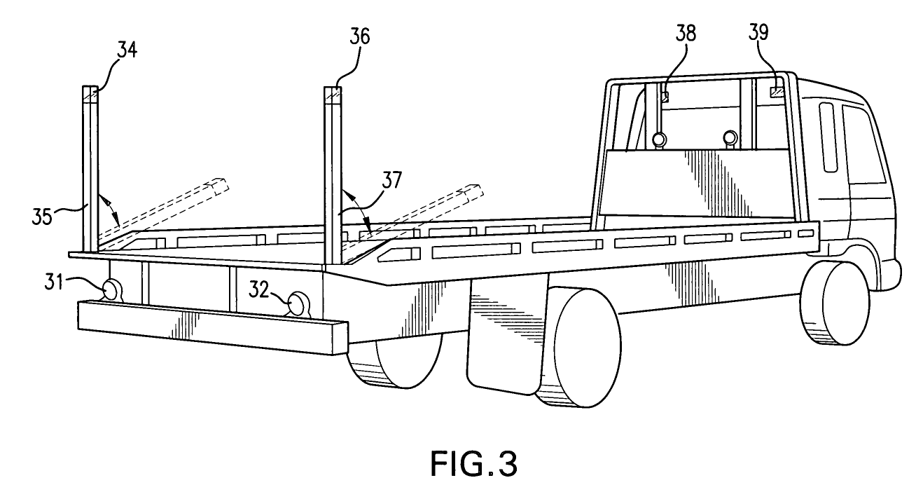

FIG. 3 is a perspective view of a flatbed truck with pivotable rear brake lights. Conventional lower brake lights are at 31 and 32. In accordance with the present invention a set of additional brake lights 34 and 36 are provided at the left and right rear of the truck on posts 35 and 37. The posts 35, 37 are vertical when in use but can be lowered, as shown by the double ended arrows. When horizontally positioned the lights 34, 36 are at the level of the platform. There are times when the posts 35, 37 need to be pivoted to the horizontal position, for example, when it is required to position or add a load and the posts need to be moved so as to not obstruct the loading operation. Thus the posts can alternate between vertical and horizontal positions. It is a simple matter to lower the holder to a horizontal level and when conditions warrant to move or pivot the holders to a vertical position. The apparatus pivoting the holders to the vertical or horizontal positions can be done manually or mechanically. The exact nature of the apparatus is subject to simple design and is not the subject matter of this invention. It will be appreciated that the number of possible truck configurations with and without trailers is huge.

Depending on the type of vehicle or truck the additional rear brake lights, as in FIG. 2, could additionally be placed on the left and right top of the cab as shown at 38 and 39. With a trailer and cab this presents the situation where there would be two sets of lights at the rear: light set 34 and 36, and also light set 38 and 39, all on at the same time when brakes are applied affording even greater illumination. Further, in this case the cab, when disconnected from a vehicle trailer combination, would still have additional brake lights. In this respect the cab would enjoy the benefits of rear brakes lights as in FIG. 1, when the trailers are left disconnected and await loading, and the higher lights on the cab provide excellent brake warning when driving without a connected trailer. In addition to a flat bed, or a platform truck, the pivotable rear brake lights could be placed on a towed trailer such as a boat trailer, a semi or semitrailer, or a truck trailer.

The posts need not be pivotable. Boat trailers often have posts as an integral part of the trailer and these posts, which cannot pivot, make excellent candidates for the addition of rear brake lights according to the invention. Because the posts are already present they are easily adapted to have additional brake lights at the top in a manner similar to that of FIG. 3.

It may not be possible to mount the brake lights at the locations shown in FIGS. 1-3 on all vehicles. Some vehicles, because of their rear contours, would obscure such lights from view.

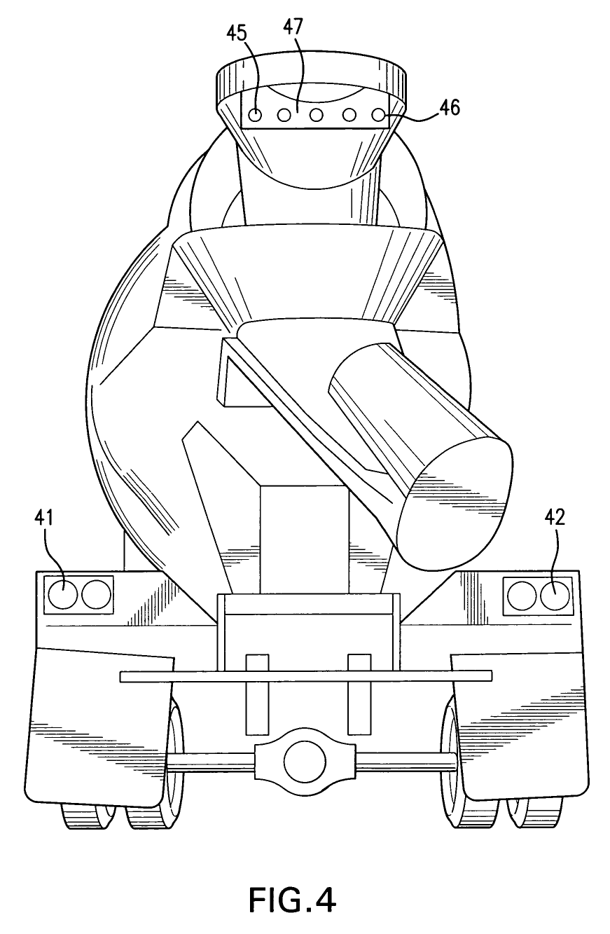

FIG. 4 is a rear view of a concrete transport truck, also referred to as a cement mixer, representative of a load so large that it would obscure additional brake lights if placed on rear windows of cabs, or where light posts would be impractical. In FIG. 4 the truck has conventional brake lights 41, 42. A series of lights 47, here shown as consisting of three lights, is affixed high at the rear of the truck. These lights 47 serve merely as illumination; the number of such lights varying among makes and models. At the top left and right of the illuminating lights are a set of additional brake lights 45, 46 to afford additional braking illumination at the rear of the truck. Dump trucks, flatbed trucks, rear loaders, roll-off trucks, pavers, tankers carrying liquids such as milk, oil or chemicals are examples of a number of vehicles with irregular rear configurations or loads that would present an obstruction to viewing the brake lights placed on the cabs of trucks and trailers. In addition the spatial distance between the bottom rear brake lights 41, 42 and the top rear brake lights 45, 46 is so large that this too increases the perception of braking.

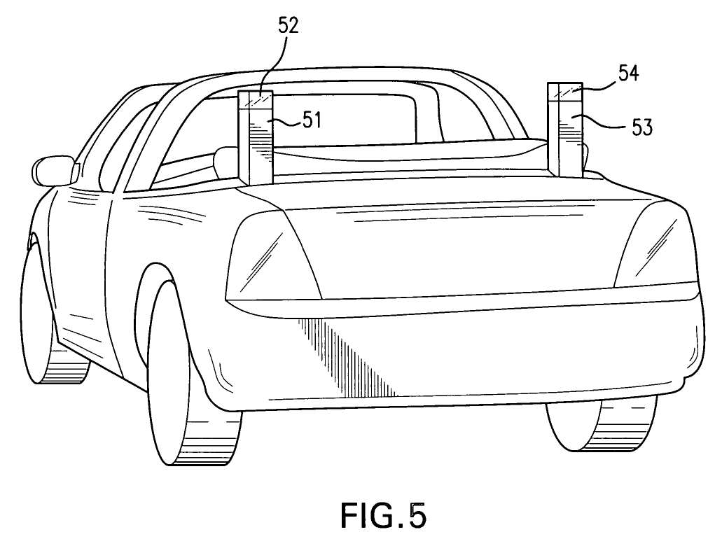

FIG. 5 shows a convertible with additional rear brake lights according to the invention. In accordance with the earlier teachings of the invention a convertible, as viewed from the rear, would have additional left and right brake lights on the rear window. A convertible, however, presents a distinctive situation such that when the top is lowered so too would any lights on the rear window. According to the invention, to maintain additional brake lights at the rear, a set of posts are raised into place as shown in FIG. 5 with posts 51, 53 supporting additional brake lights 52, 54 to be illuminated when the brakes are applied. When the top is up the vehicle acts in accordance with the teachings of FIG. 1 where the additional brake lights on the rear window turn on as the brakes are applied. In that case, with the top up, the posts are lowered out of sight. When the top is down the posts 51, 53 are raised and the brake signals are automatically switched from the rear window lights to the post mounted lights and the rear window lights cannot go on. By the same token the lights on the posts cannot be turned on when they are lowered. There are switching means, not shown, that function to selectively choose the appropriate set of brake lights to warn following drivers of braking action. The posts are preferably lowered and raised although they could be pivoted, depending on the actual vehicle type. For illustrative purposes the posts are depicted as rectangular but they could be oval, round or some aesthetic shape.

The description of FIGS. 1-5 has set forth a first set of additional brake lights at the rear of a vehicle. However this is not the complete invention. As noted, the full potential of the invention is achieved only when there are front brake lights as well as rear brake lights.

Referring once again to FIG. 1 on the front windshield 13 at the lower corners of the windshield and at approximately dashboard level are a second set of additional brake lights 16 and 18 facing forward. Facing forward means the illumination of the front brake lights is intended to be seen by an observer in front of the vehicle, or may be seen in the rear view mirror of a vehicle in front of a vehicle having forward facing brake lights. The reason for mounting these additional sets of front brake lights at the bottom corners of the windshield at dashboard level, or approximately so, in sharp contrast to prior art teachings, is that a driver will notice them quicker and react sooner. When a vehicle closely follows another vehicle the driver of the front vehicle may not even notice the headlights of the vehicle following it because the distance between the two vehicles may be too short to permit visual observation. Therefor the lights are at dashboard level so they can be seen in the rear view mirror of the front car. The curvature and vertical orientation of windshields varies as do the amount they the wrap around at their extremities. Nevertheless the placement of the front facing lights will be selected so as to provide the optimum visibility when viewed from the front. The shapes of the lights will be described later.

These second set of additional brake lights at the front cannot and must not be red for such lights would confuse drivers and pedestrians. In the present invention the preferable color for the front brake lights is yellow as this provides a distinct and sharp contrast with the headlights to denote a braking action and is also in line with most applicable legal requirements. The lights could be amber or some other color instead of yellow if permitted by law. The forward facing brake lights are energized at the same time the rear brakes.

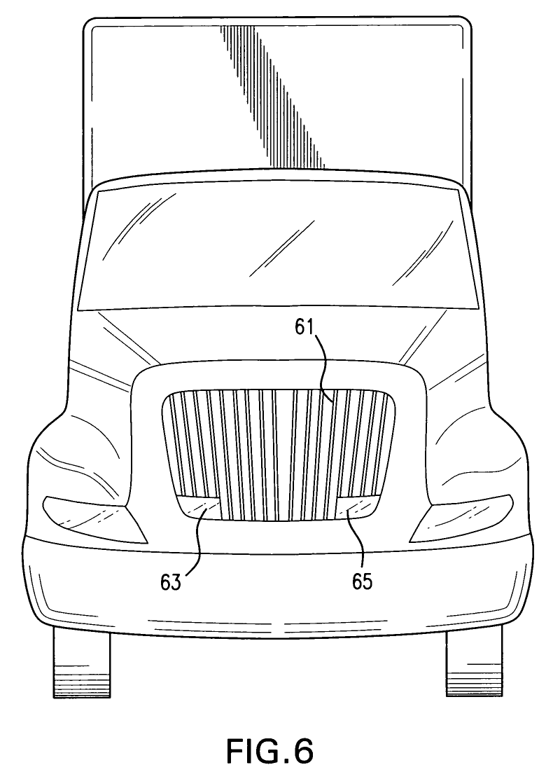

FIG. 6 shows the front view of a truck having high front bumpers with front facing brake lights according to the invention. Trucks, SUVs and the like have highly mounted cabs and front brake lights at dashboard level would be difficult to see from the rear view mirror of a vehicle in front, and almost impossible to see if the vehicles were very close. The vehicle in FIG. 6, such as a truck, has a grill 61 and conventional headlights. The additional set of front brake lights 63, 65 are positioned above the front bumper. This may require mounting the lights on the grill, as shown, but they may be mounted on the bumper depending on the height of the bumper above ground level. Placing the lights in the grill area may afford the best visibility.

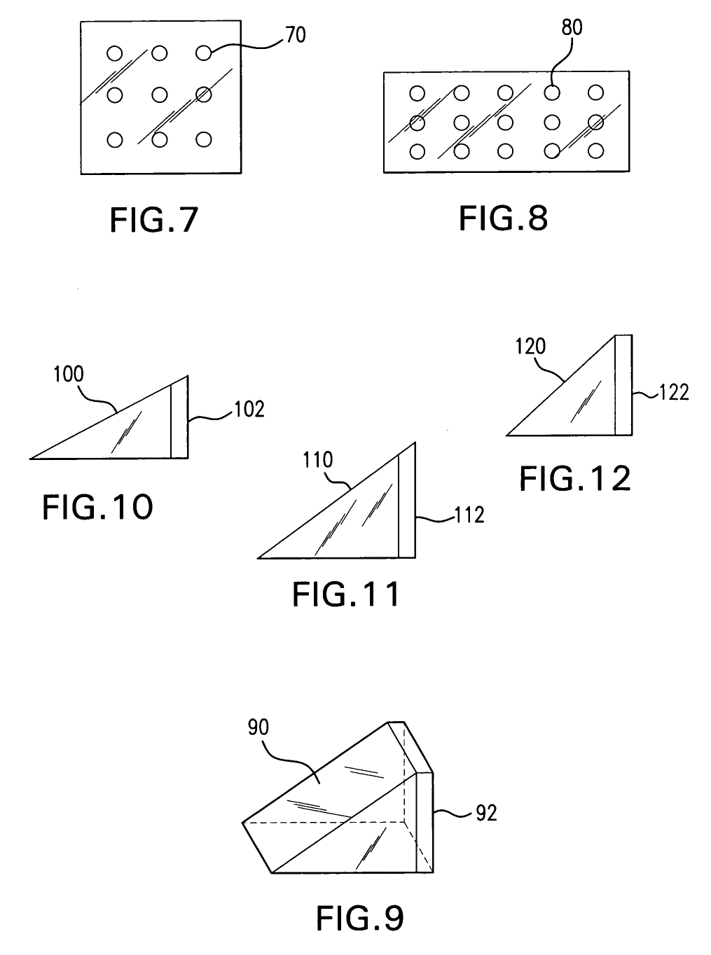

Turning now to possible LED arrangements FIG. 7 shows a first pattern of LED brake lights 70 suitable for placement at the front windshield or the rear window of a sedan and of a generally square configuration. The front and rear lights of FIG. 1 do not appear to be exactly square due to the tilt of the windshield and rear window. As seen in FIG. 7 there is a pattern of nine LED brake lights 70 in rows of three and columns of three, although there could be more or less than nine lights. The area measures about 2½ by 2½ inches but this is not intended to be limiting. There may be a need to have a non-square configuration. The forward facing LEDs can take a wide variety of forms and dimensions because front windshields have thousands of different forms and shapes, from the angles they take with respect to ground level and the distances they extend from side to side and in wrapping around the sides, among other variables. Similar considerations apply to the rear window lights.

The teaching here is that a multiplicity of LEDs are used. LEDs are preferred because they are highly efficient, draw less energy than incandescent lights, have long service lives, are durable, and can be combined in many shapes and sizes.

FIG. 8 shows a second pattern of LED brake lights suitable at the rear of a truck. The LEDs 80 are in a rectangular area measuring about 1.25 by 5 inches. Here there are three rows and five columns of LED's. These areas are illustrative only and clearly other patterns and areas are possible. In general where the rear brake lights are to be mounted on the body of the vehicle such as the cab of a truck, then the rectangular configuration is preferred. Of course it may be a matter of choice as to what configuration to employ due to the number of vehicles being built and already on the road.

FIG. 9 is illustrative of the plastic enclosure for the front brake lights. The enclosure has a surface 90 which will abut the windshield. The LEDs, such as those of FIG. 7, are on a support 92 aligned in a vertical orientation with the result that the illumination from the LED's thereon are directed forwardly. The casing and enclosure could compliment the color of the dashboard and the side of the enclosure facing the driver could have an opaque finish to prevent disturbing the driver from any possible light effects from the LEDs. The result is an aesthetically pleasing enclosure and casing which will not disturb the driver's vision. The surface 90 would have a slope approximating the slope of the windshield and to match it exactly if possible. Thus with steeper windshields the slopes would correspondingly increase. The enclosure could be adhesively mounted on the dashboard surface or the windshield or both to keep it firmly in place.

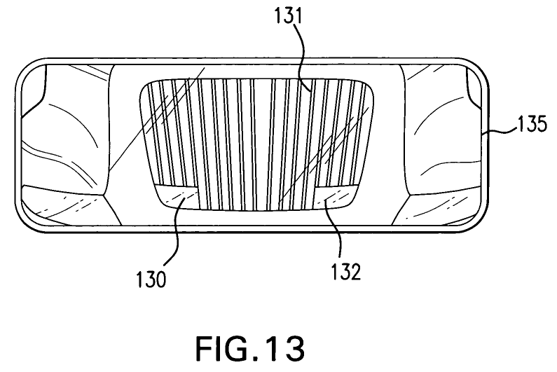

The actual casing and enclosure will vary from vehicle to vehicle. FIGS. 10-12 show different enclosures. In FIG. 10 enclosure the surface 100 has a gradual slope which slope is different from surface 110 in FIG. 11. Note the LED tops of casings 102, 112 of FIGS. 10 and 11 approximate the slope of the windshield so that the tops of the casings 100, 110 of FIGS. 10 and 11 are contiguous with the top of the LED casing 102, 112. In FIG. 12 the surface 120 has a slope not much different from FIG. 11 but the top is flat and not contiguous with the windshield. Thus it will be appreciated that as the shape of windshields can take innumerable forms the enclosures will need to similarly vary to take into account the various slopes encountered in the art.

The effect height has on a driver's ability to see front facing brake lights in a vehicle behind the driver depends, among many factors, on the height of the front facing brake lights and the distance between the front vehicle and the following vehicle. With reference to FIG. 13 the effect of height can be seen. In FIG. 13 numeral 135 represents the outline of a rear view mirror. A large vehicle or truck, such as the one in FIG. 6, is behind the vehicle and all that can be seen at some particular moment in the rear view mirror is represented in FIG. 13. At the particular moment shown one can see only the grill 131 of the following vehicle. Normally it would not be possible to determine if this following vehicle were braking or not. But with the front facing brake lights 130 and 132 mounted on the grill it is possible to determine from the activation of the brake lights 130, 132 if brakes are applied.

The most advantageous height for front brake lights on a large vehicle is from approximately 18 inches to about sixty inches. It is believed that at heights less than 18 inches a front brake light cannot readily be seen as the path of illumination from the light source to the rear view mirror emanates from too low a point. At heights greater than about 60 inches front brake lights cannot be seen as the path of illumination from the light source to the rear view mirror is from too high a source. At intermediate heights front brake lights can be seen. Thus SUVs, high vans, or trucks or any other vehicle that have an extremely high front end, as compared to passenger cars, sedans and the like, need to have their front facing brake lights at a height as described so that a driver in front of them can see the brake lights and take appropriate action, if need be. The 18 to 60 inch range is the most advantageous height range but no limitation on height is intended as variations abound among innumerable vehicles as to height, width and overall size.

1. A vehicle with standard brake lights, the improvement comprising:
a first set of additional brake lights positioned near the top rear of said vehicle, said first set of additional lights providing indications of braking when illuminated, and
a second set of additional brake lights positioned at the front of said vehicle and facing forward and providing indications of braking when illuminated.

2. The vehicle of claim 1 wherein said first set of additional brake lights is fixed to the top left and right of said vehicle.

3. The vehicle of claim 1 wherein said first set of additional brake lights is fixed to the left and right rear window of said vehicle.

4. The vehicle of claim 1 wherein said second set of additional brake lights is located on the windshield of said vehicle at dashboard level.

5. The vehicle of claim 1 wherein said second set of additional brake lights is mounted on the grill of said vehicle.

6. The vehicle of claim 1 wherein said second set of additional brake lights is mounted on the bumper of said vehicle.

7. A vehicle with standard brake lights, the improvement comprising:
a first set of additional brake lights positioned near the rear of said vehicle, said first set of set of additional brake lights alternating between vertical and horizontal positions, said first set of additional lights providing indications of braking when illuminated, and
a second set of additional brake lights positioned at the front of said vehicle facing forward and providing indications of braking when illuminated.

8. The vehicle of claim 7 wherein said first set of additional brake lights pivots between said vertical and horizontal positions.

9. The vehicle of claim 7 wherein said first set of additional brake lights is raised and lowered between said vertical and horizontal positions

10. The vehicle of claim 7 wherein said second set of additional brake lights is located on the windshield of said vehicle at dashboard level.

11. The vehicle of claim 7 wherein said second set of additional brake lights mounted on the grill of said vehicle.

12. The vehicle of claim 7 wherein said second set of additional brake lights mounted on the bumper of said vehicle.

13. A vehicle coupled to a trailer with standard brake lights at the rear of said trailer, the improvement comprising:
a first set of additional brake lights positioned at the rear of said trailer on the top of posts, said first set of additional lights providing indications of braking when illuminated, and
a second set of additional brake lights positioned at the front of said vehicle facing forward and providing indications of braking when illuminated.

14. The vehicle of claim 13 wherein said posts are fixedly secured to said trailer

15. The vehicle of claim 13 wherein said second set of additional brake lights is mounted on the grill of said vehicle.

16. The vehicle of claim 14 wherein said second set of additional brake lights is mounted on the grill of said vehicle.

17. The vehicle of claim 13 wherein said vehicle is a cab and an additional set of rear brake lights is mounted at the rear of said cab.
